(19) United States
(12) Patent Application Publication
(10) Pub. No.: US 2025/0254452 A1
(43) Pub. Date: Aug. 7, 2025

(54) Back Box Shim

(71) Applicant: Nick Berry, Las Vegas, NV (US)

(72) Inventor: Nick Berry, Las Vegas, NV (US)

(73) Assignee: Origin Acoustics, LLC, Las Vegas, NV (US)

(21) Appl. No.: 19/046,387

(22) Filed: Feb. 5, 2025

Related U.S. Application Data
(60) Provisional application No. 63/550,447, filed on Feb. 6, 2024.

(51) Int. Cl. H04R 1/02

(52) U.S. Cl. CPC H04R 1/026; H04R 2201/021

(57) ABSTRACT

A speaker back box that provides an enclosure with a finite internal volume that is configured to retain a speaker behind an outer surface of a wall. The enclosure is sized with a depth to fit between opposing sides of a wall surface and width that is sized to fit between vertical studs. The box has side flanges that are configured for securing the box on studs and behind a drywall or sheetrock facing. The box has a recess for securing shims that provide a planar surface that can be adjusted with one or more shims to make the outer surface parallel with the finished wall surface. This allows the speaker back box to accommodate a variety of surface finishes from simple painting to tile or rock face. The finite internal volume allows the box to be tuned to mounted speakers and minimizes sound pressure inside the wall.

### CROSS-REFERENCE TO RELATED APPLICATIONS

This application claims the benefit of Provisional Application Ser. No. 63/550,447 filed Feb. 6, 2024, the entire contents of which is hereby expressly incorporated by reference herein.

### PRIOR ART

U.S. Pat. No. 5,330,144 issued on Jul. 19, 1994, to Bruce B. Stevenson et al. and is titled Frame Structure and Assembly for Wall Mounting a speaker or Camera. This patent discloses a mounting frame structure for association with a preformed aperture in a wall and for recessed mounting of a speaker or camera having a housing. The frame structure includes a one-piece, unitary frame body having an open central region for receiving therethrough body portions of the housing. The frame body has a flattened perimeter region and apertures individually located in the perimeter region. The frame structure also includes a shoulder region upstanding rearwardly from and extending substantially about the perimeter region. A mounting flange upstands rearwardly in a perpendicular direction from the perimeter region. The mounting flange has a generally flat shape and at least one aperture therethrough so that the mounting flange abuts and secures to a stud or cross-member of the wall. Optionally, the frame structure is utilized in an assembly with a mounting bracket for the camera or speaker and a cover plate thereover. While this patent discloses unitary frame body, the frame does not allow for variations in drywall or sheet rock thickness.

U.S. Pat. No. 6,360,842 issued on Mar. 26, 2002, to Christopher E. Combest and is titled In-wall speaker mounting apparatus. This patent discloses an in-wall speaker mounting apparatus adapted to attach to adjacent studs in a wall is provided. Such stud attachment permits the weight of the apparatus as well as any speakers attached to the apparatus to be supported by the studs and not the wall in which the apparatus is mounted. The apparatus comprises a backwall and four upstanding sidewalls. At least one sidewall or the backwall is provided with an access hole which serves as an entry point for speaker wire or the like. At least one, and preferably two opposing sidewalls are provided with a pair of apertures each having a fixture assembly mounted thereto. The fixture assembly comprises a spacer mount having a flanged portion flush with the exterior portion of the sidewall and an exteriorly threaded region extending into the apparatus. A flanged hex nut is threaded onto the threaded region of the spacer mount with the flanged portion of the hex nut flush with the interior portion of the sidewall. As the hex nut is threaded onto the spacer mount, the two flanged portions are drawn securely against the sidewall. A spacer has a bore therethrough is then inserted through the hole in the hex nut and threaded through a bore in the spacer mount. The spacer is of sufficient length to contact the nearest adjacent stud when extended and is adjusted to such a point when installing the apparatus. A fixture is then inserted into the hole in the spacer and secured to the contacted stud. While there is adjustment for spacing between studs there is no adjustment for wall board thickness.

U.S. Pat. No. 6,550,570 issued on Apr. 22, 2003, to Christopher E. Combest and is titled Speaker Enclosure and Mounting Method for Isolating and Insulating Faceplate and Speakers from A Surrounding Mounting Surface. This patent discloses a speaker enclosure comprising a speaker box having an opening and adapted for mounting within a wall upon a wall stud, a compressible gasket affixed about the box opening, a faceplate, and a plurality of independently adjustable coupling mechanisms, for coupling the faceplate, with the box. The uncompressed gasket protrudes beyond the wall surface until the faceplate is brought into contact with and compresses the gasket by the coupling mechanisms which may be independently adjusted to provide an optimum and substantially uniform degree of separation between faceplate and wall, thereby reducing distortion, vibration, and damage due to undesirable contact therebetween. This patent relies upon a gasket to account for the thickness of a wall but does not use shims for a constat thickness of the flange to account for the wall thickness.

What is needed is a wall recessed speaker box that allows for adjustment of the wall thickness, so the speaker sits flat on the wall. The back box shim disclosed in this document provides the solution.

### BACKGROUND OF THE INVENTION

Modern installation of speakers in a wall requires installing the speakers within the wall so the appearance of the speakers do not obstruct the look of accompanying frameless TVs, the speaker needs to complement the room with a modern and slim bezel-less frame while maintaining a speaker that is clean in both appearance and sound. Once the speaker is installed, the speakers become a part of the environment where they disappear.

### SUMMARY OF THE INVENTION

It is an object of the back box shim to provide a speaker enclosure with a finite volume. The finite volume allows for any sonic pressures within the box to remain within the box both to tune the speaker(s) and to minimize sound outside of the box and air expansion outside of the box.

It is an object of the back box shim to provide a speaker enclosure that fits with an area between two parallel wall surfaces. Most interior walls are constructed with 2×4 studs, and occasionally 2×6 studs, while exterior walls are commonly constructed with 2×6 or larger stud walls. The back box shim is fabricated to fit within these different wall thickness and is typically 3.5 inches in depth, but other depths are contemplated.

It is another object of the back box shim to provide a speaker enclosure that fits between wall studs. Typical stud walls are placed 16 inches on center, and when using 2× material the width is 14.5 inches. While this is the width, the height can vary depending upon the height of the speakers to be enclosed within.

It is another object of the back box shim to have an outer lip for mounting on studs. The outer lip is typically configured to fit onto 1.5-inch width studs. This allows the back box shim to be mounted directly onto the studs and under drywall, sheetrock or another wall surface.

It is still another object of the back box shim to have an inner recess for supporting one or more shims. The shims engage and position onto a recess in the box. One or a number of shims are stackable to match the finished wall thickness from a thin ⅜-inch drywall to a tile or rock surface that can add more than an inch of thickness to the original wall surface.

Various objects, features, aspects, and advantages of the present invention will become more apparent from the following detailed description of preferred embodiments of the invention, along with the accompanying drawings in which like numerals represent like components.

### BRIEF DESCRIPTION OF DRAWINGS

FIG. 1 shows a perspective view of a back box shim.

FIG. 2 shows a rear perspective view of the back box shim.

FIG. 3 is a left side view of the back box shim.

FIG. 4 is a bottom cross-sectional view taken from 4-4 in FIG. 5.

FIG. 5 shows a front view of the back box shim.

FIG. 6 is a right cross-sectional view taken from 6-6 in FIG. 5.

FIG. 7 is a perspective view of several back box shims in an environment of use.

### DETAILED DESCRIPTION OF THE INVENTION

Item Numbers and Description

| | |
|---|---|
| 19 TV | 20 back box shim |
| 21 outer lip | 22 drywall lip |
| 23 inner wall | 24 shim wall |
| 25 back wall | 26 back boss |
| 30 shim face | 31 hole |
| 32 centering boss | 33 hole |
| 40 electrical pocket | 50 vertical stud |
| 55 back wall | 56 front wall |
| 57 wall covering | 58 low range speaker |
| 59 high range speaker | 60 thick shim |
| 62 centering boss | 63 fastener hole |
| 65 middle shim | 70 outer shim |
| 72 centering boss | 73 fastener hole |
| 90 lip dimension | 91 thick shim thickness |
| 92 thin shim thickness | 93 box width |
| 94 box depth | 95 drywall lip thickness |
| 96 shim thickness | 98 subbase speakers |
| 99 side speakers | |

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention but is merely representative of various embodiments of the invention. The illustrated embodiments of the invention will be best understood by reference to the drawings, wherein like parts are designated by like numerals throughout.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise.

It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters.

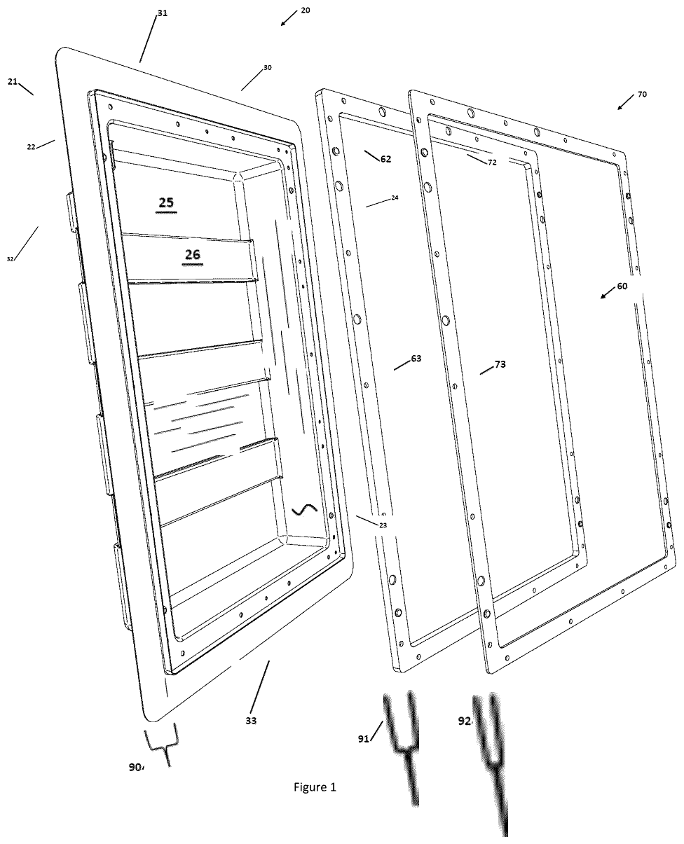

FIG. 1 shows a perspective view of a back box shim 20. The back box shim is for in-wall speaker installation wherein each speaker will include full wrap around magnetic shims, such as a thick shim 60 and an outer shim 70 of various stackable depths, as a thick shim thickness 91 and a thin shim thickness 92 to address the number one issue with Invisible speakers which is the depth between the structural wall/ceiling and the finished surface which could be a shallow surface, a thick surface, of a stacked multi material multi thickness depth to surface as might be shown installed in other figure(s) herein.

The back box shim 20 enclosure is constructed as a pan configuration surrounded with an outer lip 21 that is configured to mount on wall studs within a wall. The outer lip 21 dimension 90 allows for the back box shim 20 to be secured with nails, screw or other fasteners. There is a raised drywall lip 22 that surrounds the inner recessed inner wall 23. There is further an inner shim wall 24 where one or a plurality of shims 60, 70 are placed. The rear of the back box shim 20 shows a back wall 25 and a raised back boss 26 to provides some structural support to the back box shim 20.

The shim face 30 can have some magnetic attraction or can be made from a ferrous material that provides some magnetic attraction. This figure shows the shim face 30 of the back box shim 20 with one or a plurality of holes 31 and 33. These can be used for fasteners that can pass through the shim fastener hole(s) 63, 73 and into the back box shim 20. There is also at least one raised centering hole 32 that fits into a recess in the shim(s) 60, 70 to locate and retain the position of the shim(s) 60, 70 in the back box shim 20 in centering boss(s) 62, 72. The shim(s) 60, 70 have 180 degree rotation symmetry so they can be placed in either orient of rotation.

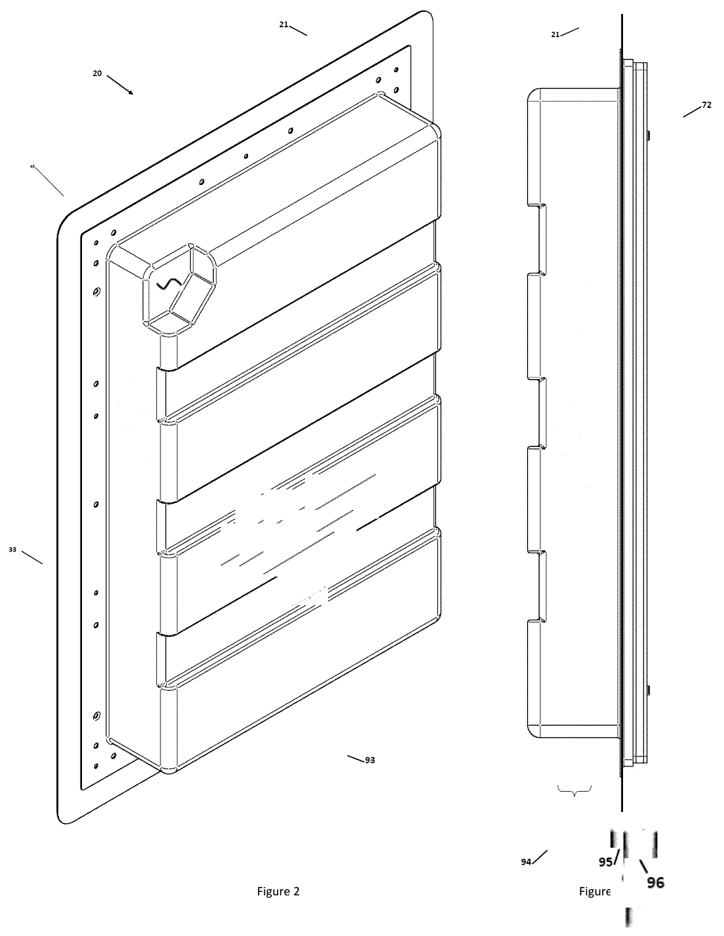

FIG. 2 shows a rear perspective view of the back box shim 20 and FIG. 3 is a left side view of the back box shim 20. In FIG. 2 the electrical pocket 40 is shown where electrical or speaker sound wiring can be brought into the back box shim 20. The box width 93 is configured to fit between common wall studs that are typically 1.5 inches wide and placed 16 inches on center for a width of less than 14.5 inches. While this width is identified, the width can be constructed for other stud spacing from 12 inches on-center to 24 inches on-center or other obvious variations thereof. The back of the outer lip 21 is shown with the mounting hole(s) 33.

From the side view the box depth 94 is shown on one side of the outer lip 21. The thickness of one or a plurality of shims having a drywall lip thickness 95 and a shim thickness 96 for wall coverings of tile, rock or other surface treatments. At least one of the centering bosses 72 for the stacked shims is visible extending beyond the outer surface of the outer shim. The centering bosses 72 also provides a position for attracting, centering, and securing an outer speaker grill (not shown).

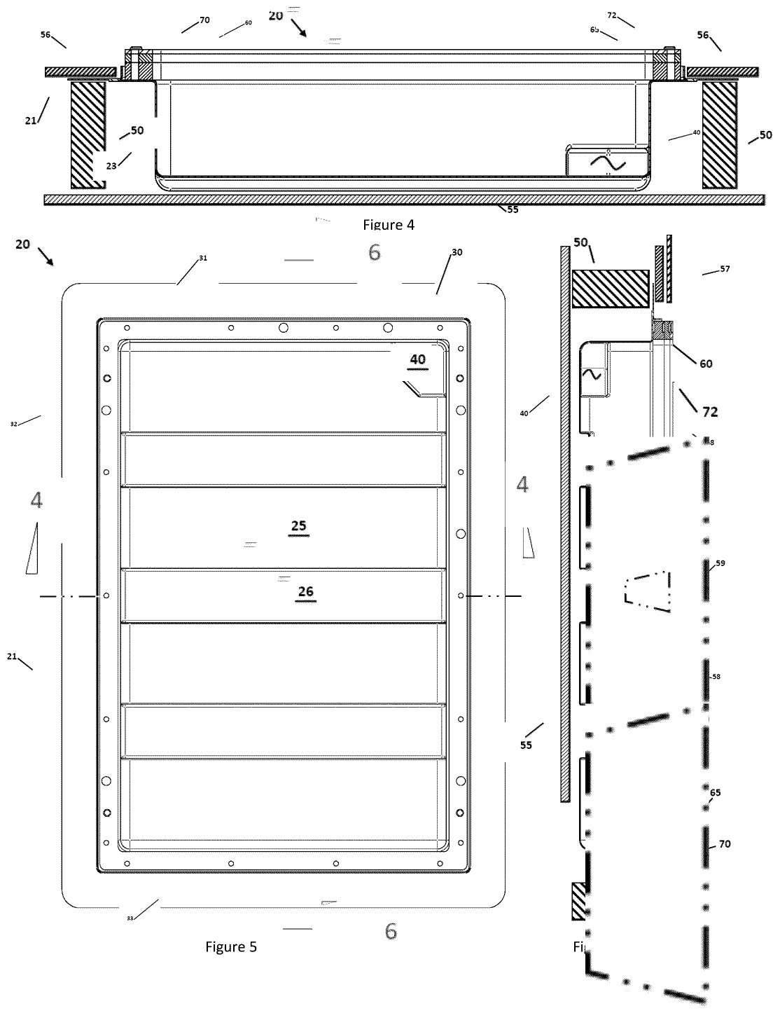

FIG. 4 is a bottom cross-sectional view taken from 4-4 in FIG. 5, FIG. 5 shows a front view of the back box shim 20 and FIG. 6 is a right cross-sectional view taken from 6-6 in FIG. 5. Starting from the front view the electrical pocket 40 can be seen in the upper right corner, but the back box shim 20 can be rotated so the electrical pocket 40 can be placed at another rotation as desired per the installation. This plan view shows the back wall 25 and the three back boss(s) 26 that provide some structural strength to the back box shim 20 to reduce flexing of the back box shim 20 and the back wall. This plan view also shows the optional mounting holes 31, 33 and the raised centering hole 32. The flat shim face 30 is shown within the outer lip 21 that is used for mounting the back box shim 20 on wall studs.

The top sectional view shows electrical pocket 40 in the lower right side of the figure. The depth of the inner wall 23 of the back box shim 20 is shown between the front wall 56 and the back wall 55 spaced by the vertical studs 50. This figure shows the thick shim 60, then a middle shim 65 topped by the outer shim 70. While the shims are given different titles, the shims are constructed in thickness of 1/16 inch, ⅛ inch, ¼ inch, ½ inch and ⅝ inch thickness and can be stacked in any order to obtain the desired height. The centering boss 72 is shown extending from the outer shim 70. While specific thickness has been indicated, the thicknesses can be in other dimensions as well as in other units, such as metric.

The side sectional view and in this view phantom lines for two mid or low range speaker(s) 58 are shown with a high range speaker 59. While these frequency ranges are given, they are provided as examples, and in addition, a greater or lesser number of each speaker type is contemplated. A wall covering 57, such as tile, rock or other material is shown where the quantity of shims is selected to make the outer surface of the back box shim 20 consistent with the finished wall surface.

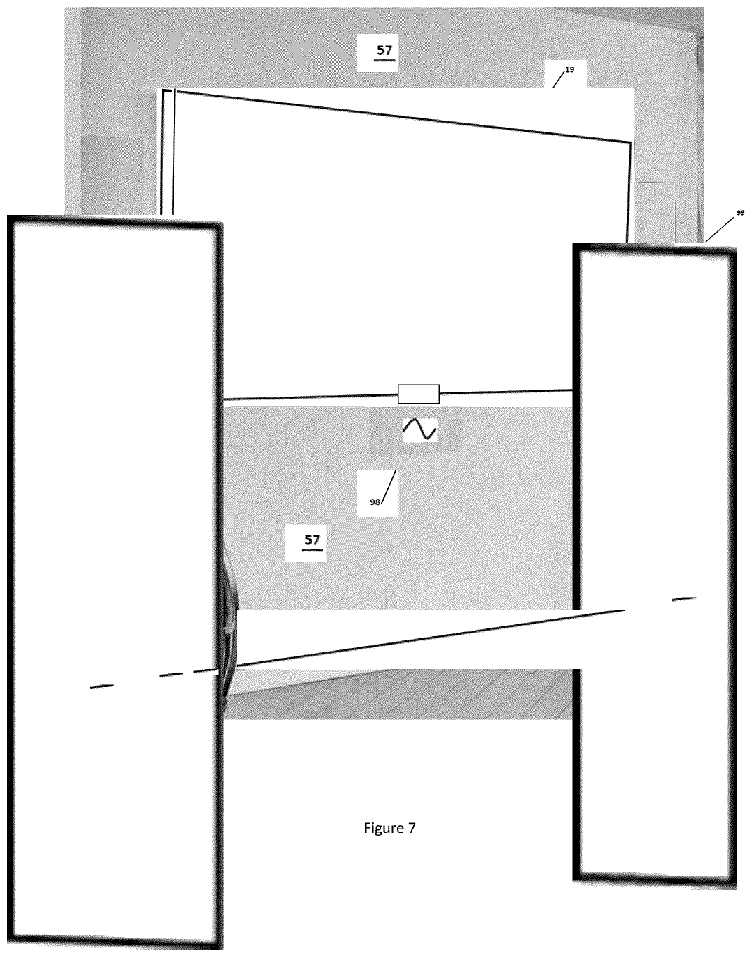

FIG. 7 is a perspective view of several back box shims in an environment of use. This is a view of three back box shim(s) installed behind a wall covering 57. A television 19 monitor or other display device is mounted on a wall. Below the television is a sub-woofer or base speaker 98 covered with a sound transparent covering. On the two sides of the television 19 are side speakers 99 that can have one or a plurality of speakers enclosed therein and also covered by a sound transparent covering. In this installation the speakers appear “fairly” invisible in the finished wall covering 57.

Thus, specific embodiments of a back box shim have been disclosed. It should be apparent, however, to those skilled in the art that many more modifications besides those described are possible without departing from the inventive concepts herein. The inventive subject matter, therefore, is not to be restricted except in the spirit of the appended claims.

1. A back box shim comprising:
a back pan having a depth as an outer flange;
said flange being configured for securing to at least two wall studs under an outer drywall or sheetrock board;
said flange further including a raised drywall lip;
said back pan further includes a shim face, and
said shim face includes a securing mechanism for securing at least one shim that extends at least planar to said drywall or sheetrock board.

2. The back box shim according to claim 1, wherein said securing mechanism is a magnetism.

3. The back box shim according to claim 1, wherein said back pan further includes an electrical pocket.

4. The back box shim according to claim 1, wherein said electrical pocket extends into a side of said back pan.

5. The back box shim according to claim 1, wherein said electrical pocket extends into a corner of said back pan.

6. The back box shim according to claim 1, wherein said at least one shim has a thickness of between 1/16 of an inch to ⅝ of an inch.

7. The back box shim according to claim 1, wherein there are at least two at least one shims.

8. The back box shim according to claim 7, wherein said shims are stackable on said back box.

9. The back box shim according to claim 1, wherein said at least one shim has 180-degree rotation symmetry.

10. The back box shim according to claim 1, wherein said raised lip has at least one locating tab.

11. The back box shim according to claim 9, wherein said at least one shim has at least one recessed locating recess.

12. The back box shim according to claim 10, wherein said at least one shim has at least one locating tab.

13. The back box shim according to claim 1, further includes at least one speaker.

14. The back box shim according to claim 1, wherein said back pan has a depth to fit within a wall that is framed with 4 to 6 inch lumber wall studs.

15. The back box shim according to claim 1, wherein back pan has a width to fit between 16 inch on-center wall studs.

16. The back box shim according to claim 1, wherein said back box accommodates surface finishes of paint, tile, marble, granite or rock face.

17. The back box shim according to claim 16, wherein said at least one shim creates a front surface that is planar with said surface finish.

18. The back box shim according to claim 16, wherein said at least one shim further includes an outer grill or fabric cover that is planar with said surface finish.

19. The back box shim according to claim 1, wherein said back box minimizes sound pressure outside of said back box.

20. The back box shim according to claim 19, wherein said back box has a finite interior volume.
